(19) United States
(12) Patent Application Publication
(10) Pub. No.: US 2026/0337086 A1
(43) Pub. Date: Oct. 29, 2026

(54) METHODS AND APPARATUS FOR MANUFACTURING A RIBBON

(71) Applicant: CORNING INCORPORATED, CORNING, NY (US)

(72) Inventors: Nils Paul Fornell, Harrodsburg, KY (US); Keith Mitchell Hill, Horseheads, NY (US)

(21) Appl. No.: 19/102,641

(22) PCT Filed: Aug. 28, 2023
(86) PCT No.: PCT/US2023/031222

§ 371 Date: Feb. 10, 2025

Related U.S. Application Data
(60) Provisional application No. 63/374,414, filed on Sep. 2, 2022.

(51) Int. Cl. C03B 35/24; B65H 20/02; B65H 20/14; B65H 23/032

(52) U.S. Cl. CPC C03B 35/246; B65H 20/02; B65H 20/14; B65H 23/032

(57) ABSTRACT

A glass manufacturing apparatus (100) includes a forming apparatus (101) that forms a glass ribbon (103) and defines a first travel path (109) of the glass ribbon (103). The glass manufacturing apparatus (100) includes a support bearing (203, 205) including a bearing surface (307, 327) and a plurality of openings (309, 329) through which gas exits to impinge upon the glass ribbon (103). The support bearing (203, 205) moves between a first position, in which the bearing surface (307, 327) is spaced a distance apart from the first travel path (109), and a second position, in which the bearing surface (307, 327) engages the glass ribbon (103) and guides the glass ribbon (103) to move along a second travel path (361) different from the first travel path (109). Methods of manufacturing a glass ribbon are provided.

### CROSS-REFERENCE TO RELATED APPLICATIONS

This application claims the benefit of priority under 35 U.S.C. § 119 of U.S. Provisional Application Serial No. 63/374414 filed on Sep. 2, 2022, the content of which is relied upon and incorporated herein by reference in its entirety.

### FIELD

The present disclosure relates generally to methods for manufacturing a glass ribbon and, more particularly, to methods for manufacturing a glass ribbon by supporting the glass ribbon with a support bearing.

### BACKGROUND

It is known to manufacture molten material into a glass ribbon with a glass manufacturing apparatus. The glass ribbon can be stored by winding the glass ribbon into a roll with a winding apparatus. However, delivering a spool of glass to a winding apparatus in a clean environment can be expensive and time-consuming. Further, accommodating for position changes of the glass ribbon during the spooling process can be difficult.

### SUMMARY

The following presents a simplified summary of the disclosure to provide a basic understanding of some aspects described in the detailed description.

In aspects, one or more support bearings can be positioned within a clean room environment between a forming apparatus and a winding apparatus. The support bearings can guide a glass ribbon from the forming apparatus to the winding apparatus without contacting the glass ribbon. The support bearings can adjust a lateral position of the glass ribbon if the glass ribbon becomes off-centered by controlling a flow of gas across a width of the glass ribbon. One or more rollers positioned downstream from the support bearings and upstream from the winding apparatus can guide the glass ribbon to the winding apparatus and change positions to adjust for non-planar regions of the glass ribbon.

In aspects, a glass manufacturing apparatus comprises a forming apparatus configured to form a glass ribbon and defining a first travel path of the glass ribbon. The glass manufacturing apparatus comprises a support bearing comprising a bearing surface and a plurality of openings through which gas exits to impinge upon the glass ribbon. The support bearing moves between a first position, in which the bearing surface is spaced a distance apart from the first travel path, and a second position, in which the bearing surface engages the glass ribbon and guides the glass ribbon to move along a second travel path different from the first travel path.

In aspects, the support bearing comprises a first zone comprising a first portion of the plurality of openings through which gas exits and configured to impart a first force upon the glass ribbon. The support bearing comprises a second zone comprising a second portion of the plurality of openings through which gas exits and configured to impart a second force less than the first force upon the glass ribbon.

In aspects, the glass manufacturing apparatus comprises a first set of drag rollers and a second set of drag rollers spaced apart and positioned downstream from the support bearing. The first set of drag rollers engages a first edge of the glass ribbon and the second set of drag rollers is configured to engage an opposing second edge of the glass ribbon.

In aspects, the first set of drag rollers comprises a first drag roller and a second drag roller spaced apart defining a gap. The first edge of the glass ribbon is received within the gap. The second set of drag rollers comprises a third drag roller and a fourth drag roller spaced apart defining a second gap. The second edge of the glass ribbon is received within the second gap.

In aspects, the first set of drag rollers and the second set of drag rollers are movable between a first position, in which a first distance separates the first set of drag rollers and the second set of drag rollers, and a second position, in which a second distance separates the first set of drag rollers and the second set of drag rollers. The first distance is different than the second distance.

In aspects, the first drag roller is movable relative to the second drag roller to adjust a size of the gap.

In aspects, the glass manufacturing apparatus comprises a drive roller extending through an opening in the bearing surface and positioned upstream from the first set of drag rollers and the second set of drag rollers. The drive roller is configured to engage the glass ribbon.

In aspects, a glass manufacturing apparatus comprises a forming apparatus configured to form a glass ribbon and defining a first travel path of the glass ribbon. The glass manufacturing apparatus comprises a support bearing comprising a bearing surface and a plurality of openings through which gas exits to impinge upon the glass ribbon. The support bearing comprises a first zone comprising a first portion of the plurality of openings through which gas exits and configured to impart a first force upon the glass ribbon. The support bearing comprises a second zone comprising a second portion of the plurality of openings through which gas exits and configured to impart a second force less than the first force upon the glass ribbon. The glass manufacturing apparatus comprises a gas source in fluid communication with the support bearing. The gas source is configured to deliver gas to the support bearing and through the plurality of openings to guide the glass ribbon.

In aspects, the glass manufacturing apparatus comprises a first set of drag rollers and a second set of drag rollers spaced apart and positioned downstream from the support bearing. The first set of drag rollers is configured to engage a first edge of the glass ribbon and the second set of drag rollers is configured to engage an opposing second edge of the glass ribbon.

In aspects, the first set of drag rollers comprises a first drag roller and a second drag roller spaced apart defining a gap. The first edge of the glass ribbon is received within the gap. The second set of drag rollers comprises a third drag roller and a fourth drag roller spaced apart defining a second gap. The second edge of the glass ribbon is received within the second gap.

In aspects, the first set of drag rollers and the second set of drag rollers are movable between a first position, in which a first distance separates the first set of drag rollers and the second set of drag rollers, and a second position, in which a second distance separates the first set of drag rollers and the second set of drag rollers. The first distance is different than the second distance.

In aspects, the first drag roller is movable relative to the second drag roller to adjust a size of the gap.

In aspects, the glass manufacturing apparatus comprises a drive roller extending through a channel in the bearing surface and positioned upstream from the first set of drag rollers and the second set of drag rollers. The drive roller is configured to engage the glass ribbon.

In aspects, methods of manufacturing a glass ribbon comprise moving the glass ribbon along a first travel path in a first travel direction. Methods comprise emitting gas from a support bearing. Methods comprise moving the support bearing from a first position, in which the support bearing is spaced a distance apart from the first travel path, to a second position, in which gas from the support bearing impinges upon the glass ribbon and guides the glass ribbon to move along a second travel path different from the first travel path.

In aspects, emitting gas comprises emitting gas from a first zone of the support bearing comprising a first portion of a plurality of openings and imparting a first force upon the glass ribbon, and emitting gas from a second zone of the support bearing comprising a second portion of the plurality of openings and imparting a second force upon the glass ribbon. The second force is less than the first force.

In aspects, the first zone and the second zone are arranged substantially perpendicular to the second travel path.

In aspects, methods comprise contacting the glass ribbon with a first set of drag rollers and a second set of drag rollers positioned downstream from the support bearing relative to the first travel direction.

In aspects, methods comprise changing a travel path of the glass ribbon by moving the first set of drag rollers and the second set of drag rollers.

In aspects, methods can comprise, at a location upstream from the contacting the glass ribbon with the first set of drag rollers and the second set of drag rollers, providing a portion of the glass ribbon as unsupported and hanging freely under the influence of gravity.

Additional features and advantages of the aspects disclosed herein will be set forth in the detailed description that follows, and in part will be clear to those skilled in the art from that description or recognized by practicing the aspects described herein, including the detailed description which follows, the claims, as well as the appended drawings. It is to be understood that both the foregoing general description and the following detailed description present aspects intended to provide an overview or framework for understanding the nature and character of the aspects disclosed herein. The accompanying drawings are included to provide further understanding and are incorporated into and constitute a part of this specification. The drawings illustrate various aspects of the disclosure, and together with the description explain the principles and operations thereof.

### BRIEF DESCRIPTION OF THE DRAWINGS

These and other features, aspects and advantages are better understood when the following detailed description is read with reference to the accompanying drawings, in which:

FIG. 1 schematically illustrates example aspects of a glass manufacturing apparatus in accordance with aspects of the disclosure;

FIG. 2 schematically illustrates example aspects of a glass manufacturing apparatus with support bearings in an initial first position in accordance with aspects of the disclosure;

FIG. 3 illustrates a perspective view of a pair of support bearings in accordance with aspects of the disclosure;

FIG. 4 illustrates a side view of the pair of support bearings in accordance with aspects of the disclosure;

FIG. 5 illustrates a top-down view of a support bearing in accordance with aspects of the disclosure;

FIG. 6 schematically illustrates example aspects of the glass manufacturing apparatus with support bearings in an initial first position in accordance with aspects of the disclosure;

FIG. 7 schematically illustrates example aspects of the glass manufacturing apparatus with support bearings in an initial first position in accordance with aspects of the disclosure;

FIG. 8 schematically illustrates example aspects of the glass manufacturing apparatus with support bearings in an initial first position in accordance with aspects of the disclosure;

FIG. 9 illustrates a perspective view of a support bearing and a plurality of drag rollers in accordance with aspects of the disclosure;

FIG. 10 illustrates a side view of the plurality of drag rollers in accordance with aspects of the disclosure;

FIG. 11 illustrates a top-down view of the plurality of drag rollers and winding apparatus in accordance with aspects of the disclosure;

FIG. 12 illustrates a perspective view of the plurality of drag rollers and drive rollers in accordance with aspects of the disclosure;

FIG. 13 illustrates a perspective view of the plurality of drag rollers and winding apparatus in accordance with aspects of the disclosure;

FIG. 14 illustrates a perspective view of the plurality of drag rollers and winding apparatus in accordance with aspects of the disclosure; and

FIG. 15 illustrates a perspective view of the winding apparatus in accordance with aspects of the disclosure.

### DETAILED DESCRIPTION

Aspects will now be described more fully hereinafter with reference to the accompanying drawings in which example aspects are shown. Whenever possible, the same reference numerals are used throughout the drawings to refer to the same or like parts. However, this disclosure may be embodied in many different forms and should not be construed as limited to the aspects set forth herein.

As used herein, the term “about” means that amounts, sizes, formulations, parameters, and other quantities and characteristics are not, and need not be, exact, but may be approximate and/or larger or smaller, as desired, reflecting tolerances, conversion factors, rounding off, measurement error and the like, and other factors known to those of skill in the art.

Ranges can be expressed herein as from “about” one value, and/or to “about” another value. When such a range is expressed, another aspect includes from the one value to the other value. Similarly, when values are expressed as approximations by use of the antecedent “about,” it will be understood that the value forms another aspects. It will be further understood that the endpoints of each of the ranges are significant both in relation to the other endpoint, and independently of the other endpoint.

Directional terms as used herein—for example up, down, right, left, front, back, top, bottom, upper, lower, etc.—are made only with reference to the figures as drawn and are not intended to imply absolute orientation.

Unless otherwise expressly stated, it is in no way intended that any methods set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including: matters of logic with respect to arrangement of steps, operational flow, order of components, or orientation of components; plain meaning derived from grammatical organization or punctuation, and; the number or type of aspects described in the specification.

As used herein, the singular forms “a,” “an” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including”, and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to represent that a described feature is equal or approximately equal to a value or description. For example, a “substantially planar” surface is intended to denote a surface that is planar or approximately planar. Moreover, “substantially” is intended to denote that two values are equal or approximately equal. In aspects, “substantially” may denote values within about 10% of each other, such as within about 5% of each other, or within about 2% of each other.

Modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first end and a second end generally correspond to end A and end B or two different or two identical ends or the same end.

The present disclosure relates to a glass support apparatus and methods for supporting a spool of glass. For purposes of this application, a “ribbon” may be considered one or more of a glass ribbon in a viscous state, a glass ribbon in an elastic state (e.g., at room temperature) and/or a glass ribbon in a viscoelastic state between the viscous state and the elastic state. In aspects, the “ribbon” can comprise films, foils (e.g., copper, aluminum, conductive material that is ultra-thin), plastic, polymer, metals papers, fibers, ceramic, or glass-ceramic materials. Methods and apparatus for supporting a spool of glass will now be described by way of example aspects. For purposes of the disclosure, in aspects, a glass manufacturing apparatus can comprise a glass forming apparatus that forms a glass article (e.g., a glass ribbon) from a quantity of molten material. In aspects, the glass ribbon can be employed in a variety of display applications comprising, but not limited to, liquid crystal displays (LCDs), electrophoretic displays (EPD), organic light emitting diode displays (OLEDs), plasma display panels (PDPs), touch sensors, photovoltaics, foldable phones, etc.

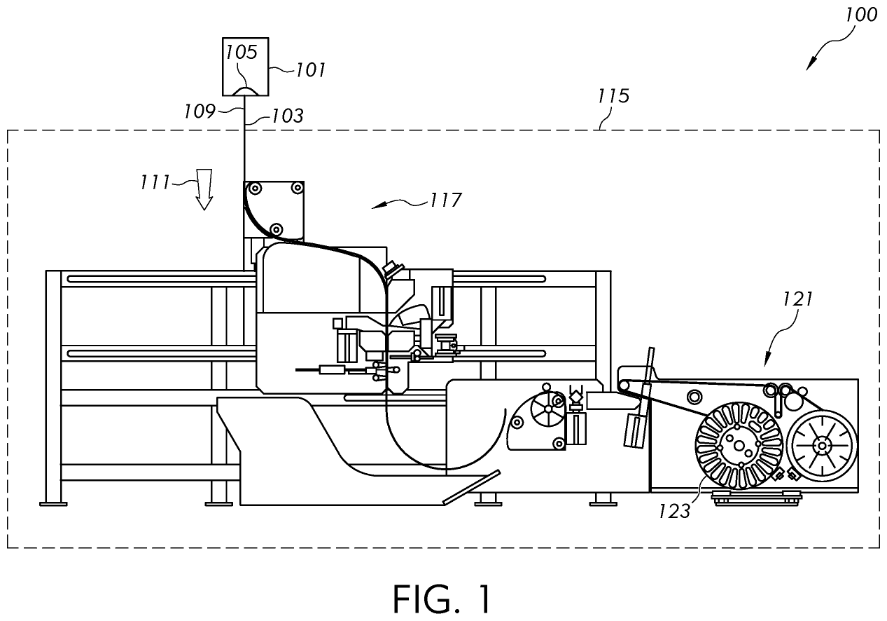

As schematically illustrated in FIG. 1, in aspects, an exemplary glass manufacturing apparatus 100 can comprise a forming apparatus 101 configured to form a glass ribbon 103. In aspects, the forming apparatus 101 can comprise a slot draw apparatus, float bath apparatus, down-draw apparatus, up-draw apparatus, press-rolling apparatus, or other glass forming apparatus that forms a glass ribbon. In aspects, the forming apparatus 101 can comprise a delivery conduit through which the glass ribbon 103 can exit the forming apparatus 101. For example, the delivery conduit can comprise a passageway with an opening 105. The delivery conduit can be oriented along a direction of gravity, such that the glass ribbon 103 can flow downwardly along the direction of gravity through the delivery conduit.

In aspects, the forming apparatus 101 can define an upstream portion of a travel path 109 extending in a travel direction 111. The forming apparatus 101 can convey the glass ribbon 103 along the upstream portion of the travel path 109 in the first travel direction 111. In aspects, the forming apparatus 101 can be positioned at an exterior of a clean room environment 115, with one or more portions of the glass manufacturing apparatus 100 positioned within the clean room environment 115. The clean room environment 115 can be contained within one or more walls (e.g., illustrated with dashed lines in FIG. 1) and may comprise a reduced level of particulates (e.g., dust, airborne organisms, vaporized particles, etc.) as compared to a level of particulates at an exterior of the clean room environment 115. In aspects, the clean room environment 115 may be maintained at a positive pressure relative to an exterior of the clean room environment 115 such that gas may flow from the clean room environment 115 to an environment exterior to the clean room environment 115. In aspects, a pressure differential between the clean room environment 115 and the exterior environment may be about 5 pascals or more. In aspects, the clean room environment 115 can comprise an ISO (“International Organization for Standardization”) 6 clean room.

The glass ribbon 103 can enter the clean room environment 115 through an opening, for example, in a ceiling of the clean room environment 115. As the glass ribbon 103 enters the clean room environment 115, the glass ribbon 103 can be directed by one or more support bearings 117 along a travel path toward a winding apparatus 121, whereupon the glass ribbon 103 can be wound into a roll. The one or more support bearings 117 may be positioned within the clean room environment 115. The winding apparatus 121 can comprise, for example, a spool 123 that may comprise a substantially circular cross-sectional shape. The spool 123 can receive the glass ribbon 103, whereupon the glass ribbon 103 can be wound around the spool 123 and into a roll. Accordingly, in aspects, methods of manufacturing the glass ribbon 103 can comprise moving the glass ribbon 103 along the travel path 109 in the first travel direction 111, for example, to the winding apparatus 121.

In aspects, the glass ribbon 103 can hang down, and, due to the gravitational force exerted upon the glass ribbon 103, the glass ribbon 103 can tend to remain centered relative to the one or more support bearings 117, thus producing a stable system or configuration. For example, the glass ribbon 103 may tend to self-center and, even when supported by the one or more support bearings 117, the glass ribbon 103 may return to a center position that is centered relative to the one or more support bearings 117. In aspects, the one or more support bearings 117 can exert a greater pressure on edges of the glass ribbon 103 than at the center of the glass ribbon 103, such that the glass ribbon 103 will tend to remain centered relative to the one or more support bearings 117. In addition, the glass ribbon 103 can comprise a free loop (e.g., immediately upstream from the winding apparatus 121), wherein the weight of the free loop can further assist in centering the glass ribbon 103 due to the weight of the glass ribbon 103 in the free loop and the effect of gravitational force. The free loop can comprise a portion of the glass ribbon 103 that is unsupported (e.g., by the support bearings 117 or other support structures) and, thus, hangs freely at a location upstream from the winding apparatus 121. Accordingly, the glass ribbon 103 can be centered in the width direction due, at least in part, to the free loop and the one or more support bearings 117.

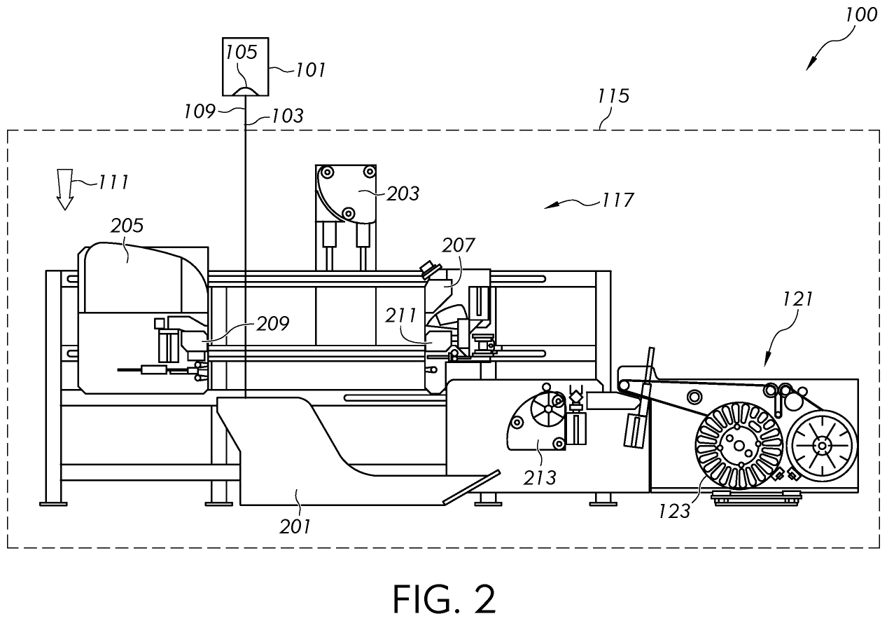

FIG. 2 illustrates the glass manufacturing apparatus 100 when the one or more support bearings 117 are in an initial position. In the initial position, the one or more support bearings 117 can be spaced apart from the glass ribbon 103 and the travel path 109, such that the one or more support bearings 117 may not guide, direct, or otherwise move the glass ribbon 103. Rather, the glass ribbon 103 can travel along the travel path 109 in a vertical orientation under the influence of gravity. In aspects, the one or more support bearings 117 may be positioned in the initial position, for example, at the beginning of the forming process. In aspects, a disposal apparatus 201 can be positioned below the forming apparatus 101, such that the glass ribbon 103 can travel into the disposal apparatus 201, whereupon the glass ribbon 103 can be crushed. In aspects, the one or more support bearings 117 can comprise a plurality of support bearings that are spaced apart along a travel path of the glass ribbon 103 from the forming apparatus 101 to the winding apparatus 121. For example, the one or more support bearings 117 can comprise a first support bearing 203, a second support bearing 205, a third support bearing 207, a fourth support bearing 209, a fifth support bearing 211, and a sixth support bearing 213. In aspects, the support bearings 203, 205, 207, 209, 211, 213 may initially be in a first position, in which the support bearings 203, 205, 207, 209, 211, 213 are spaced a distance apart from the travel path 109.

In aspects, while moving within the clean room environment 115, the glass ribbon 103 can comprise a temperature within a range from about 300 ° Celsius (“C”) to about 350 °C. The glass ribbon 103 can comprise a travel speed that is within a range from about 1 meter/minute to about 30 meters/minute, or about 1000 millimeters (“mm”)/minute to about 10,000 mm/min. The glass ribbon 103 can comprise a width within a range from about 500 mm to about 2 meters, or about 500 mm to about 600 mm, and a center thickness within a range from about 30 micrometers (“microns”) to about 200 microns, or about 50 microns to about 150 microns. The glass ribbon 103 can comprise a ribbon warp of less than about 1.5 mm.

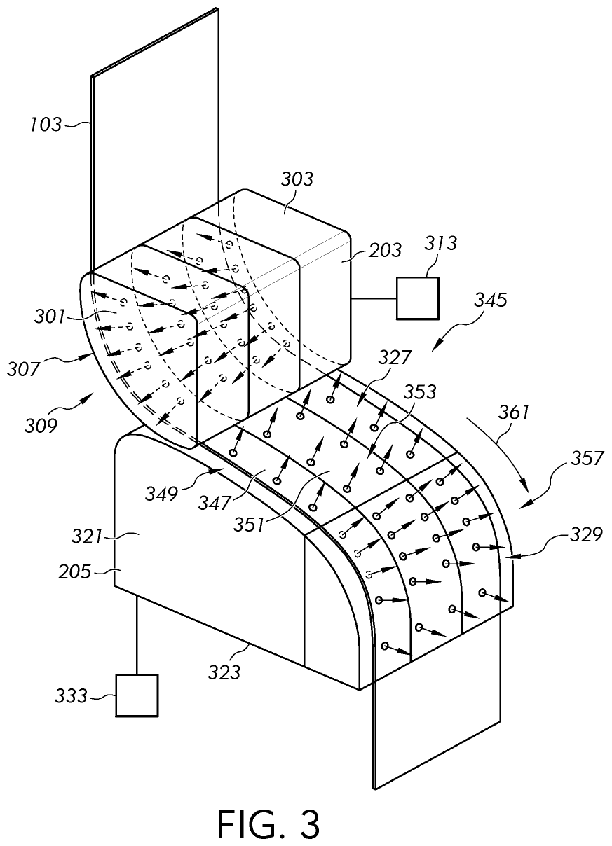

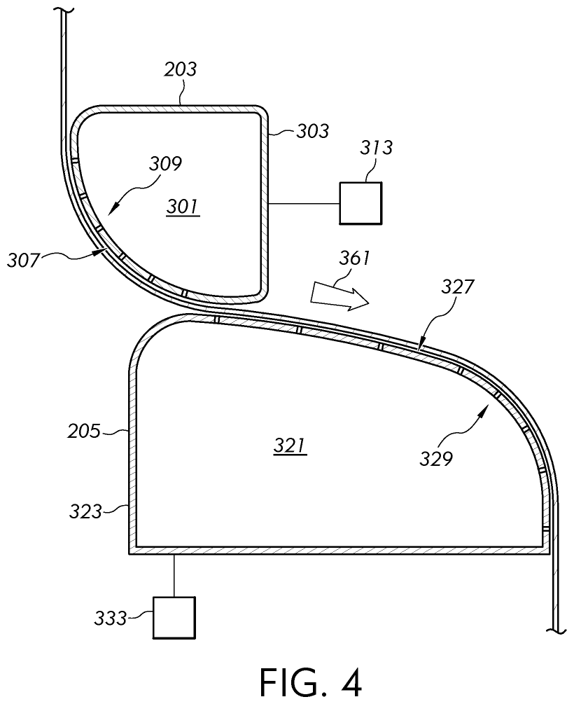

FIGS. 3-4 illustrate the first support bearing 203 and the second support bearing 205 after moving from the initial first position (e.g., illustrated in FIG. 2) to a position in which the first support bearing 203 and the second support bearing 205 engage the glass ribbon 103. FIG. 3 illustrates a perspective view of the first support bearing 203 and the second support bearing 205 and FIG. 4 illustrates a side view of the first support bearing 203 and the second support bearing 205. Initially, it is noted that the support bearings disclosed herein are not limited to the illustrated positions. Rather, based on a thickness of the glass ribbon 103, the support bearings can be placed in different positions, such that the glass ribbon 103 may experience a different degree of bending. For example, as the bending radius of the glass ribbon 103 is decreased, the glass stress may decrease. As the thickness of the glass ribbon 103 increases, a larger bend radius may be necessary, which may require a larger distance that the glass ribbon 103 travels from the forming apparatus 101 to the winding apparatus 121. In this way, the support bearings can support the glass ribbon 103 while maintaining a glass ribbon stress within a desirable range, with the glass ribbon stress based, at least in part, on the bend radius that the glass ribbon 103 experiences.

The first support bearing 203 and the second support bearing 205 may be substantially similar in structure and function to the other support bearings 207, 209, 211, 213. For example, the first support bearing 203 can comprise a substantially hollow interior first chamber 301 that may be bounded by a first wall 303. The first support bearing 203 can comprise a first bearing surface 307 and a plurality of first openings 309, extending through the first bearing surface 307, through which a gas can exit to impinge upon the glass ribbon 103. The first bearing surface 307 can be positioned adjacent to the travel path 109 such that, as the glass ribbon 103 travels from the forming apparatus 101, gas can exit through the first openings 309 and impinge upon the glass ribbon 103, thus imparting a force upon the glass ribbon 103. The first openings 309 can be spaced apart along the first bearing surface 307 and may be in fluid communication with the first chamber 301.

In aspects, a first gas source 313 can be in fluid communication with the first support bearing 203, with the first gas source 313 configured to deliver gas to the first support bearing 203 and through a plurality of openings in the first support bearing 203 to guide the glass ribbon 103. The first gas source 313 can comprise, for example, a pump, a cannister, a cartridge, a boiler, a compressor, a pressure vessel, etc., and can provide a gas (e.g., air, nitrogen, combination of gases, etc.) to the first chamber 301. In aspects, the first gas source 313 can deliver compressed gas (e.g., air, nitrogen, helium, combinations thereof, or other gases kept under a pressure that is greater than atmospheric pressure), whereupon, the gas can flow from the first gas source 313, into the first chamber 301, and through the first openings 309 toward the glass ribbon 103. In aspects, one or more fluid control devices (e.g., valves, fans, pipes, conduits, etc.) can be in fluid communication with the first gas source 313 and the first chamber 301, wherein the fluid control devices can facilitate the delivery and control of the gas to the first support bearing 203. In aspects, the first bearing surface 307 can comprise a non-planar shape, such as a curved shape as illustrated in FIG. 4, though, in aspects, the first bearing surface 307 may comprise a planar shape.

The second support bearing 205 can comprise a substantially hollow interior second chamber 321 that may be bounded by a second wall 323. The second support bearing 205 can comprise a second bearing surface 327 and a set of second openings 329 through which gas can exit to impinge upon the glass ribbon 103. The second support bearing 205 bearing surface 327 can be positioned adjacent to the travel path 109 such that, as the glass ribbon 103 travels from the forming apparatus 101, gas can exit through the second openings 329 and impinge upon the glass ribbon 103, thus imparting a force upon the glass ribbon 103. The second openings 329 can be spaced apart along the second bearing surface 327 and may be in fluid communication with the second chamber 321. In this way, a second gas source 333 can be in fluid communication with the second support bearing 205, with the second gas source 333 configured to deliver gas to the second support bearing 205 and through a plurality of openings in the second support bearing 205 to guide the glass ribbon 103. The second gas source 333 can be substantially identical to the first gas source 313. In aspects, the second gas source 333 can deliver compressed gas, whereupon, the gas can flow from the second gas source 333, into the second chamber 321, and through the second openings 329 toward the glass ribbon 103. In aspects, the second bearing surface 327 can comprise a non-planar shape, such as a curved shape as illustrated in FIG. 4, though, in aspects, the second bearing surface 327 may comprise a planar shape. Accordingly, in aspects, methods can comprise moving the support bearings 203, 205 from a first position (e.g., illustrated in FIG. 2), in which the support bearings 203, 205 are spaced a distance apart from the first travel path 109, to a second position, in which gas from the support bearings 203, 205 impinge upon the glass ribbon 103 and guide the glass ribbon 103 to move along a second travel path 357 different from the first travel path 109.

Referring to FIG. 3, in aspects, the support bearings 203, 205 can comprise a plurality of zones 345 that can apply a differential pressure to the glass ribbon 103 via gas emitted from the openings 309, 329. For example, with reference to the second support bearing 205, the second support bearing 205 can comprise a first zone 347 comprising a first portion 349 of the plurality of openings 329 through which gas exits and configured to impart a first force upon the glass ribbon 103. The second support bearing 205 can comprise a second zone 351 comprising a second portion 353 of the plurality of openings 329 through which gas exits and configured to impart a second force upon the glass ribbon 103, wherein the second force is less than the first force. In aspects, the plurality of zones 345 can be separated by one or more walls positioned within the second chamber 321. For example, a wall can be positioned between the first zone 347 and the second zone 351 within the second chamber 321 to separate the first zone 347 and the second zone 351. In this way, the first zone 347 may not be in fluid communication with the second zone 351. Likewise, the other zones may be separated by walls to limit fluid communication between two separate zones.

In aspects, the plurality of zones 345 of the second support bearing 205 can be positioned in rows and columns. The rows may be across or perpendicular to a second travel direction 361 of the glass ribbon 103, and the columns may be along or parallel to the travel direction of the glass ribbon 103. For example, the first zone 347 may be adjacent to the second zone 351, with the first zone 347 and the second zone 351 positioned within a row. In this way, the first zone 347 and the second zone 351 may be arranged substantially perpendicular to a second travel path 357 of the glass ribbon 103. By being arranged substantially perpendicular, an axis can intersect the first zone 347 and the second zone 351, with the axis lying perpendicular to a travel direction of the glass ribbon 103 as the glass ribbon 103 moves along the second travel path 357.

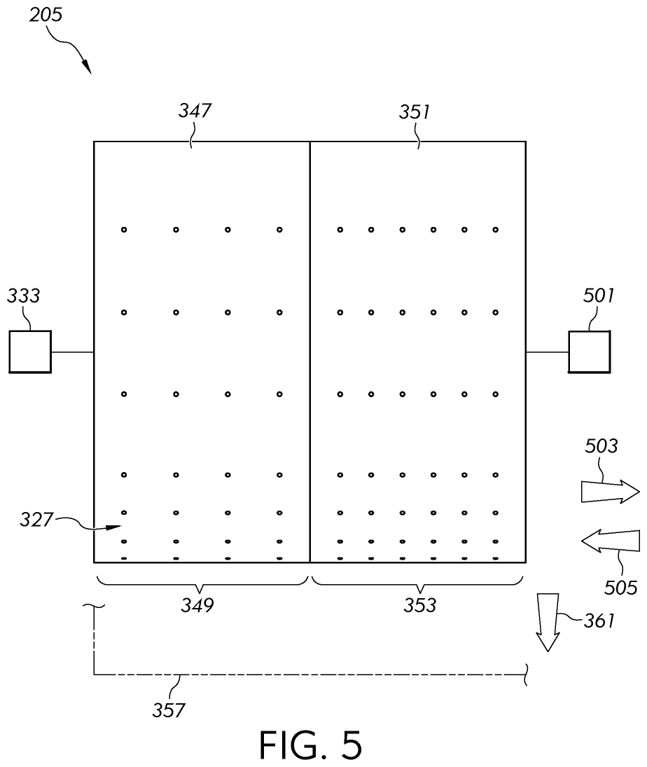

FIG. 5 illustrates a top-down view of the portion of the second support bearing 205 comprising the first zone 347 and the second zone 351. In aspects, different zones of the plurality of zones 345 can impart a different force upon the glass ribbon 103. For example, the first zone 347 can impart the first force while the second zone 351 can impart the second force, wherein the second force may be less than the first force. The plurality of zones 345 can impart different forces in several ways. For example, in aspects, the first zone 347 and the second zone 351 can comprise a different number of openings. That is, the first portion 349 of the plurality of openings may comprise fewer openings than the second portion 353 of the plurality of openings. In aspects, the openings of the second portion 353 may be in closer proximity (e.g., a distance separating adjacent openings) than the openings of the first portion 349, such that the second zone 351 may comprise more openings than the first zone 347. In addition, or in the alternative, the first portion 349 and the second portion 353 of the plurality of openings may comprise different sizes (e.g., diameters) which may further affect the force imparted by the first zone 347 and the second zone 351.

In aspects, the second support bearing 205 is not limited to comprising one gas source (e.g., the second gas source 333), but, rather, may comprise a plurality of gas sources. For example, the second support bearing 205 may comprise a gas source in fluid communication with one or more zones, such as, for example, the second gas source 333 in fluid communication with the first zone 347 and a third gas source 501 in fluid communication with the second zone 351. In this way, a differing amount of gas can be supplied to the different zones, such that the force imparted by the different zones can be different. In aspects, the second gas source 333 can deliver a first amount (e.g., volumetric flow rate) of gas to the first zone 347 and the third gas source 501 can deliver a second amount (e.g., volumetric flow rate) of gas to the second zone 351, wherein the first amount may be different than the second amount. In addition, or in the alternative, one or more fans can be provided in fluid communication with the gas sources 333, 501, to further increase or decrease the amount of gas delivered. As such, in this way, due to each zone 347, 351 comprising a different gas source and a differing number of openings 349, 353, the different zones 347, 351 can impart a different force to the glass ribbon 103. While the aforementioned discussion of the different zones 347, 351 pertained to the second support bearing 205, in aspects, some or all of the other support bearings 203, 207, 209, 211, 213 may comprise a plurality of zones that are substantially identical in structure and function to the zones 347, 351. Further, while the aforementioned discussion of the second support bearing 205 was limited to two zones 347, 351, in aspects, some or all of the support bearings 203, 205, 207, 209, 211, 213 may comprise more than two zones, with the zones substantially identical to the zones 347, 351 of FIGS. 3-5.

In aspects, by imparting a different force to the glass ribbon 103 from the zones 347, 351, the glass ribbon 103 can be directed or steered in a first transverse direction 503 or a second transverse direction 505 that are substantially perpendicular to the second travel direction 361. For example, by increasing the flow rate of gas through the first portion 349 of openings and by decreasing the flow rate of gas through the second portion 353 of openings, the force imparted by the first zone 347 may be greater than the force imparted by the second zone 351. Due to this differential force, the glass ribbon 103 can move in the first transverse direction 503 (e.g., away from the first zone 347 and toward the second zone 351) as the glass ribbon 103 travels in the second travel direction 361. Conversely, by increasing the flow rate of gas through the second portion 353 of openings and by decreasing the flow rate of gas through the first portion 349 of openings, the force imparted by the second zone 351 may be greater than the force imparted by the first zone 349. Due to this differential force, the glass ribbon 103 can move in the second transverse direction 505 (e.g., away from the second zone 351 and toward the first zone 347) as the glass ribbon 103 travels in the second travel direction 361. Accordingly, the plurality of zones 345 can adjust a position of the glass ribbon 103 by moving the glass ribbon 103 in the transverse direction 503, 505. In this way, since some, or all, of the support bearings 117 disclosed herein may comprise a plurality of zones, and, in aspects, some, or all, of the zones may comprise a separate gas source delivering gas to that particular zone, the support bearings 117 disclosed herein can control a lateral movement (e.g., in the transverse directions 503, 505) of the glass ribbon 103 as the glass ribbon 103 moves from the forming apparatus 101 to the winding apparatus 121. Accordingly, methods can comprise emitting gas from the support bearings 203, 205. Further, methods can comprise emitting gas from the first zone 347 of the second support bearing 205 comprising the first portion of the plurality of openings 349 and imparting the first force upon the glass ribbon 103, and emitting gas from the second zone 351 of the second support bearing 205 comprising the second portion of the plurality of openings 353 and imparting the second force upon the glass ribbon 103. In aspects, the second force may be less than the first force. In aspects, the flow of gas through the zones 347, 351 can be controlled by an operator, for example, based on feedback related to the glass ribbon 103 provided to the operator. In addition, or in the alternative, one or more control apparatuses (e.g., programmable logic controllers) can receive the feedback and adjust the flow of gas through the zones 347, 351, thus automating the control and/or steering of the glass ribbon 103, for example, by adjusting the flow of gas to the zones 347, 351. In aspects, to provide further support for the glass ribbon 103, the support bearings, for example, the second support bearing 205, can be adjusted and movable in the transverse direction 503, 505 to accommodate for a position of the glass ribbon 103.

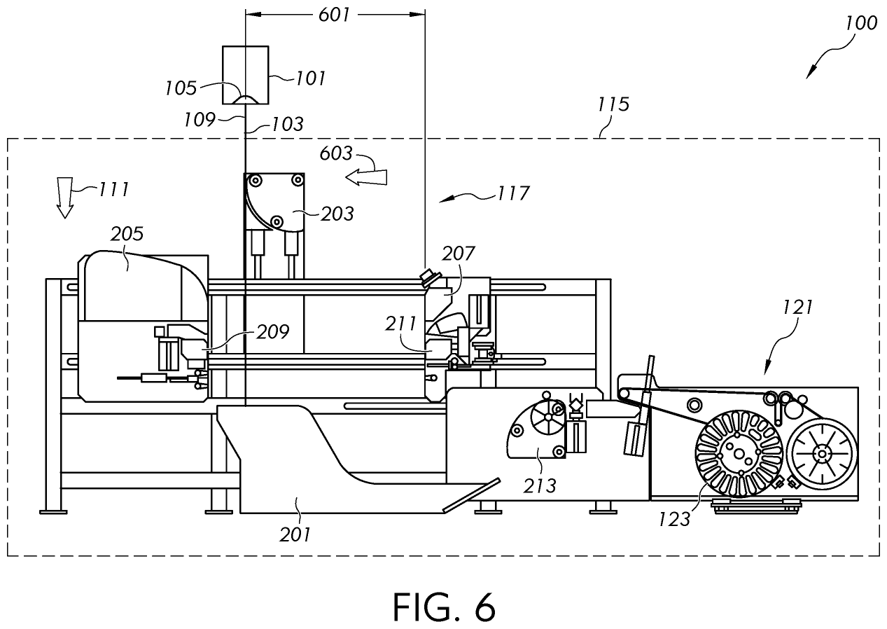

FIG. 6 illustrates the glass manufacturing apparatus 100 after the first support bearing 203 has moved from an initial first position (e.g., illustrated in FIG. 2) to a second position. In aspects, in the first position, the first support bearing 203 may initially be spaced a first distance 601 apart from the travel path 109, and in the second position, the first support bearing 203 may be adjacent to the travel path 109, such that a distance between the travel path 109 and the first support bearing 203 may be about zero. In aspects, the first support bearing 203 can move in a first movement direction 603 from the first position to the second position, wherein the first movement direction 603 may be toward the travel path 109. The glass ribbon 103 may continue to travel along the travel path 109 and into the disposal apparatus 201 as the first support bearing 203 moves in the first movement direction 603. In aspects, while the first support bearing 203 moves from the first position to the second position, the other support bearings 205, 207, 209, 211, 213 may remain stationary and spaced apart from the travel path 109.

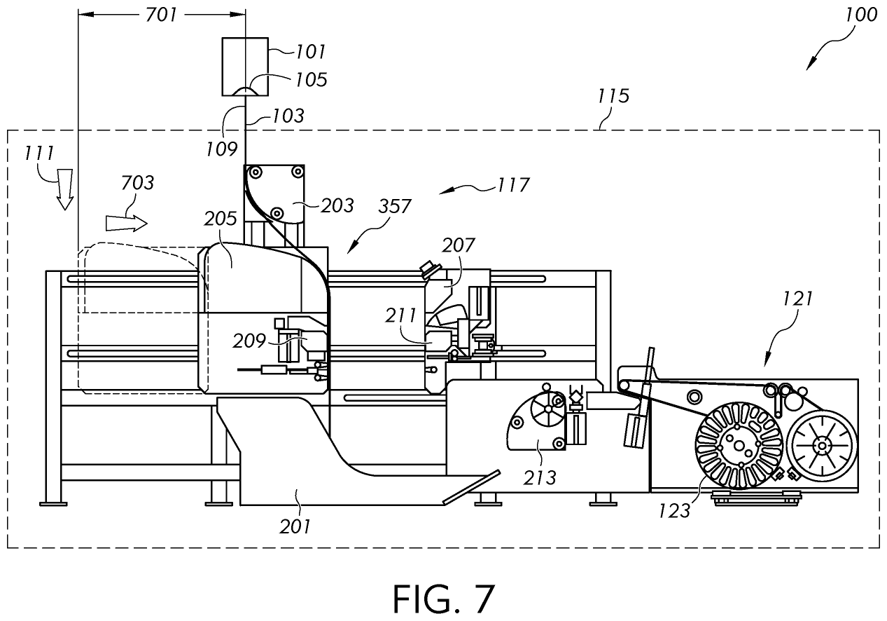

FIG. 7 illustrates the glass manufacturing apparatus 100 after the second support bearing 205 has moved from an initial first position (e.g., illustrated in FIG. 2) to a second position. FIG. 7 illustrates the first support bearing 203 and the second support bearing 205 in the same positions as illustrated in FIGS. 3-4. In aspects, in the initial first position, the second support bearing 205 may initially be spaced a first distance 701 apart from the travel path 109, and in the second position, the second support bearing 205 may be adjacent to the travel path 109, such that a distance between the travel path 109 and the second support bearing 205 may be about zero. In aspects, the second support bearing 205 can move in a first movement direction 703 from the first position to the second position, wherein the first movement direction 703 may be toward the travel path 109. The glass ribbon 103 may continue to travel along the travel path 109 and into the disposal apparatus 201 as the second support bearing 205 moves in the first movement direction 703. In aspects, while the second support bearing 205 moves from the first position to the second position, the other support bearings 207, 209, 211, 213 may remain stationary and spaced apart from the travel path 109. When the first support bearing 203 and the second support bearing 205 are in the second position, the bearing surfaces 307, 327 can engage the glass ribbon 103 and guide the glass ribbon 103 to move along the second travel path 357, which is different from the first travel path 109. For example, the first support bearing 203 can maintain an upstream portion of the glass ribbon 103 to move in a substantially vertical orientation along the first travel path 109. The second support bearing 205 can apply a force to the glass ribbon 103 and cause the glass ribbon 103 to move in the first movement direction 703, such that the glass ribbon 103 no longer travels along the first travel path 109 but, instead, travels along the second travel path 357.

In aspects, the fourth support bearing 209, which is positioned downstream from the second support bearing 205, can move from an initial first position (e.g., illustrated in FIG. 2) to a second position illustrated in FIG. 7. In aspects, in the initial first position, the fourth support bearing 209 may initially be spaced the first distance 701 apart from the travel path 109, and in the second position, the fourth support bearing 209 may be adjacent to the travel path 357, such that a distance between the travel path 357 and the fourth support bearing 209 may be about zero. In aspects, the fourth support bearing 209 can move in the first movement direction 703 from the first position to the second position. In aspects, the fourth support bearing 209 may be positioned on the same side of the glass ribbon 103 as the second support bearing 205, with the second support bearing 205 and the fourth support bearing 209 applying a force to the same side of the glass ribbon 103 to maintain the glass ribbon 103 in a substantially vertical orientation.

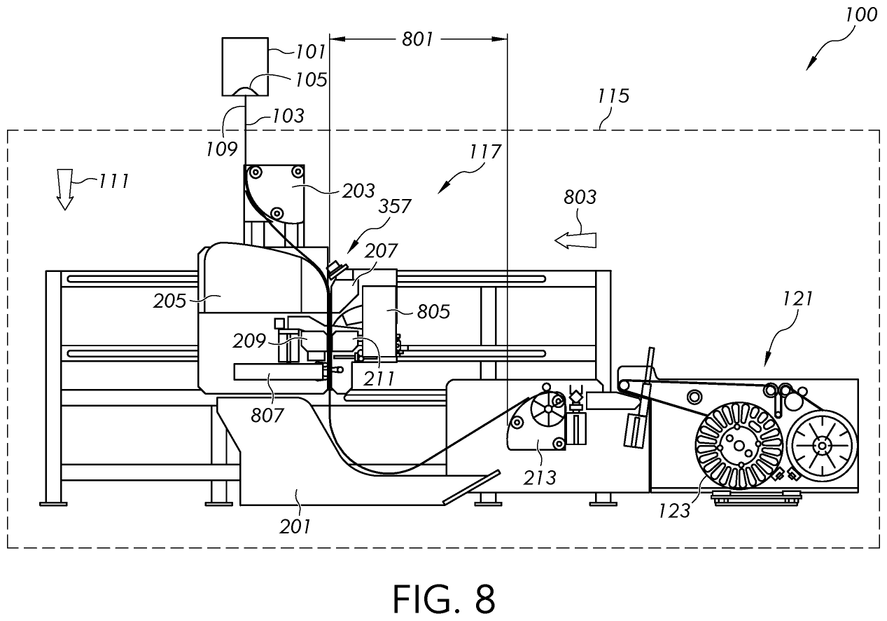

FIG. 8 illustrates the glass manufacturing apparatus 100 after the third support bearing 207 and the fifth support bearing 211 have moved from an initial first position (e.g., illustrated in FIG. 2) to a second position. In aspects, in the initial first position, the third support bearing 207 and the fifth support bearing 211 may initially be spaced a first distance 801 from the second travel path 357, and in the second position, the third support bearing 207 and the fifth support bearing 211 may be adjacent to the second travel path 357 such that a distance between the second travel path 357 and the third support bearing 207 and the fifth support bearing 211 may be about zero. In aspects, the third support bearing 207 and the fifth support bearing 211 can move in a first movement direction 803, wherein the first movement direction 803 may be toward the second travel path 357. The first movement direction 803 may be substantially identical to the first movement direction 603 (e.g., illustrated in FIG. 6) that the first support bearing moves 203. The glass ribbon 103 may continue to travel along the second travel path 357 and may no longer be directed into the disposal apparatus 201. Rather, the glass ribbon 103 can be directed to travel over the sixth support bearing 213 toward the winding apparatus 121. In aspects, while the third support bearing 207 and the fifth support bearing 211 move in the first movement direction 803, the other support bearings 203, 205, 209, 213 may remain stationary.

When the third support bearing 207 and the fifth support bearing 211 are in the second position, bearing surfaces of the third support bearing 207 and the fifth support bearing 211 can engage the glass ribbon 103 and guide the glass ribbon 103 to move along the second travel path 357. In aspects, the third support bearing 207 may be positioned on the same side of the glass ribbon 103 as the fifth support bearing 211, with the third support bearing 207 and the fifth support bearing 211 applying a force to the same side of the glass ribbon 103 to maintain the glass ribbon 103 in a substantially vertical orientation. In aspects, the third support bearing 207 and the fifth support bearing 211 may be positioned on an opposite side of the glass ribbon 103 from the second support bearing 205 and the fourth support bearing 209. For example, the second support bearing 205 and the third support bearing 207 can be spaced apart to define a gap through which the glass ribbon 103 travels, with the second support bearing 205 and the third support bearing 207 positioned at substantially the same elevation such that an axis can intersect the second support bearing 205 and the third support bearing 207, with the axis substantially perpendicular to the glass ribbon 103. In aspects, the fourth support bearing 209 and the fifth support bearing 211 can be spaced apart to define a gap through which the glass ribbon 103 travels, with the fourth support bearing 209 and the fifth support bearing 211 positioned at substantially the same elevation, downstream from the second support bearing 205 and the third support bearing 207, such that an axis can intersect the fourth support bearing 209 and the fifth support bearing 211, with the axis substantially perpendicular to the glass ribbon 103. In this way, the glass ribbon 103 can travel substantially vertically while being supported on both sides by support bearings 205, 207, 209, 211.

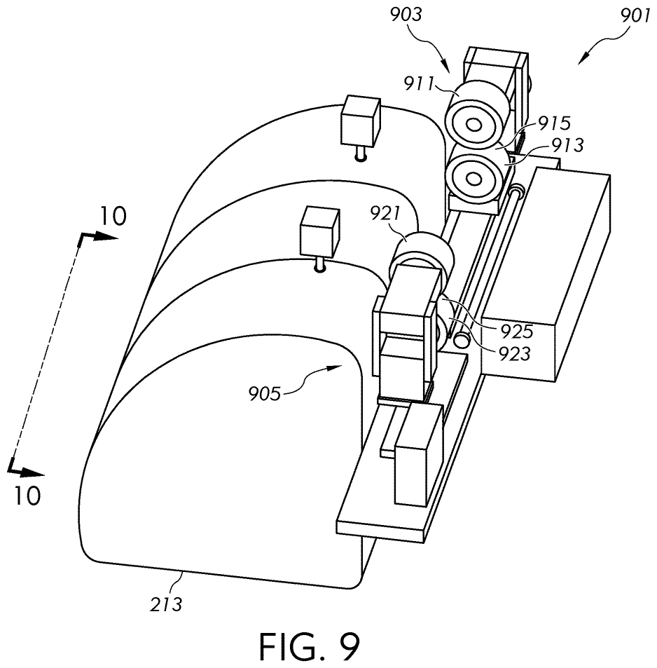

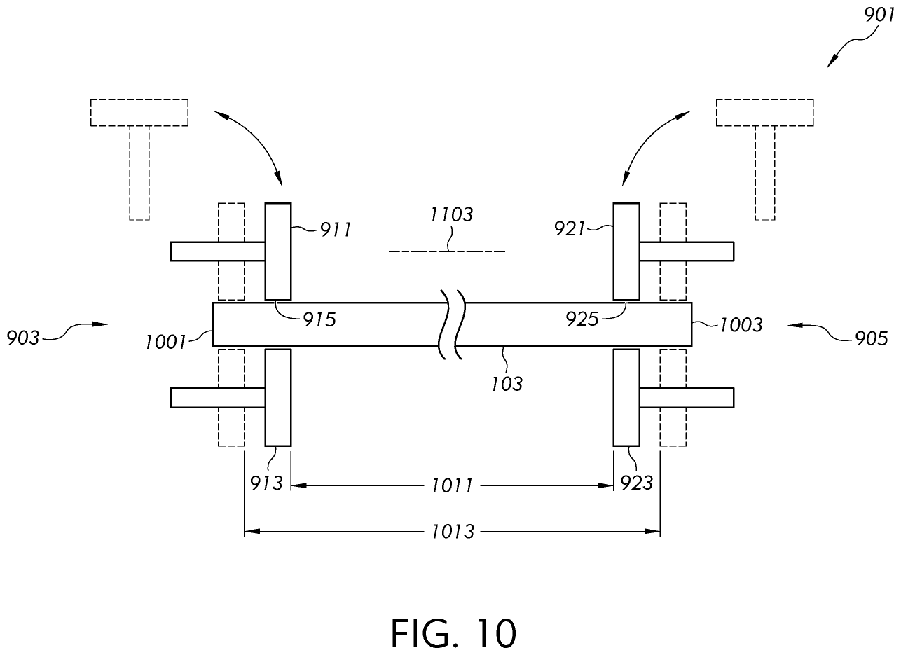

In aspects, the glass manufacturing apparatus 100 can comprise an inspection apparatus 805 for inspecting the glass ribbon 103. For example, the inspection apparatus 805 can be attached to the third support bearing 207 and the fifth support bearing 211 such that the inspection apparatus 805 can be positioned adjacent to the glass ribbon 103 as the glass ribbon 103 travels in the travel direction 111. In aspects, the inspection apparatus 805 can inspect the glass ribbon 103 and determine one or more characteristics of the glass ribbon 103, such as, for example, glass thickness, glass warp, defects (e.g., cord, streak), particulate contamination, etc. In aspects, the glass manufacturing apparatus 100 can comprise a light source 807 configured to emit light. The light source 807 can be positioned on the same side of the glass ribbon 103 as the second support bearing 205 and the fourth support bearing 209, with the light source 807 located downstream from the fourth support bearing 209. In aspects, the light source 807 can be positioned facing the glass ribbon 103 such that the light source 807 can emit light through the glass ribbon 103 toward the inspection apparatus 805. In this way, illuminating the glass ribbon 103 can facilitate inspection of the glass ribbon 103 by the inspection apparatus 805, for example, by enabling the inspection apparatus 805 to detect the characteristics of the glass ribbon 103. In aspects, a portion of the glass ribbon 103 can be unsupported and hanging freely under the influence of gravity, for example, with the portion of the glass ribbon 103 located upstream from the sixth support bearing 213 and at a location upstream from contacting the glass ribbon 103 with drag rollers (e.g., illustrated and described relative to FIGS. 9-10). The unsupported portion of the glass ribbon 103 can comprise a U-shape that hangs freely due to not being supported by any air bearings (or other support structures).

FIG. 9 illustrates a perspective view of the sixth support bearing 213. As illustrated in FIGS. 1-2 and 6-8, the sixth support bearing 213 may be positioned downstream from the fourth support bearing 209 and the fifth support bearing 211, and upstream from the winding apparatus 121. The sixth support bearing 213 may be positioned below the glass ribbon 103 such that the sixth support bearing 213 can support and direct the glass ribbon 103 toward the winding apparatus 121. In aspects, the glass manufacturing apparatus 100 can comprise a plurality of drag rollers 901 for engaging the glass ribbon 103 and directing the glass ribbon 103 toward the winding apparatus 121. In aspects, the plurality of drag rollers 901 can be positioned downstream from the sixth support bearing 213 such that, after passing the sixth support bearing 213, the glass ribbon 103 can contact the plurality of drag rollers 901. In aspects, the plurality of drag rollers 901 can comprise a first set of drag rollers 903 positioned along a first edge of the glass ribbon 103, and a second set of drag rollers 905 positioned along a second edge of the glass ribbon 103. In this way, the first set of drag rollers 903 and the second set of drag rollers 905 are spaced apart and positioned downstream from the sixth support bearing 213. The first set of drag rollers 903 can comprise a first drag roller 911 and a second drag roller 913 spaced apart defining a gap 915. The second set of drag rollers 905 can comprise a third drag roller 921 and a fourth drag roller 923 spaced apart defining a second gap 925.

FIG. 10 illustrates a side view of the plurality of drag rollers as viewed along lines 10-10 of FIG. 9. The first set of drag rollers 903 can engage a first edge 1001 of the glass ribbon 103 and the second set of drag rollers 905 can engage an opposing second edge 1003 of the glass ribbon 103. In this way, the first edge 1001 of the glass ribbon 103 can be received within the gap 915 between the first drag roller 911 and the second drag roller 913. The opposing second edge 1003 of the glass ribbon 103 can be received within the second gap 925 between the third drag roller 921 and the fourth drag roller 923. In this way, the plurality of drag rollers 901 can rotate while contacting the glass ribbon 103 as the glass ribbon 103 moves toward the winding apparatus 121. Accordingly, methods can comprise contacting the glass ribbon 103 with the first set of drag rollers 903 and the second set of drag rollers 905 positioned downstream from the sixth support bearing 213 relative to the travel direction 111, 361 of the glass ribbon 103.

In aspects, the plurality of drag rollers 901 are not fixed at one position, but, rather, can move to accommodate a shape and/or a position of the glass ribbon 103. For example, the first set of drag rollers 903 and the second set of drag rollers 905 can be moved in a direction parallel to a surface of the glass ribbon 103 and perpendicular to a travel direction of the glass ribbon 103. In this way, the first set of drag rollers 903 and the second set of drag rollers 905 are movable between a first position (e.g., illustrated with solid lines in FIG. 10), in which a first distance 1011 separates the first set of drag rollers 903 and the second set of drag rollers 905, and a second position (e.g., illustrated with dashed lines in FIG. 10), in which a second distance 1013 separates the first set of drag rollers 903 and the second set of drag rollers 905. In aspects, the first distance 1011 may be different than the second distance 1013, for example, with the first distance 1011 less than the second distance 1013 in FIG. 10.

In addition to the movement of the plurality of drag rollers 901 to adjust between the distances 1011, 1013, one or more of the drag rollers 901 can pivot between an opened position and a closed position. For example, the first roller 911 can pivot between the closed position (e.g., illustrated with solid lines in FIG. 10) in which the first roller 911 contacts the first edge 1001 of the glass ribbon 103 and the gap 915 is formed between the rollers 911, 913, and an opened position (e.g., illustrated with dashed lines in FIG. 10) in which the first roller 911 is spaced apart from and not in contact with the glass ribbon 103. Likewise, third roller 921 can pivot between the closed position (e.g., illustrated with solid lines in FIG. 10) in which the third roller 921 contacts the second edge 1003 of the glass ribbon 103 and the gap 925 is formed between the rollers 921, 923, and an opened position (e.g., illustrated with dashed lines in FIG. 10) in which the third roller 921 is spaced apart from and not in contact with the glass ribbon 103. In the closed position, the rollers 911, 913, 921, 923 can contact the surfaces of the glass ribbon 103 and constrain the glass ribbon 103. In the opened position, a portion of the rollers 911, 921 are not in contact with the surface of the glass ribbon 103 such that the glass ribbon 103 is unconstrained.

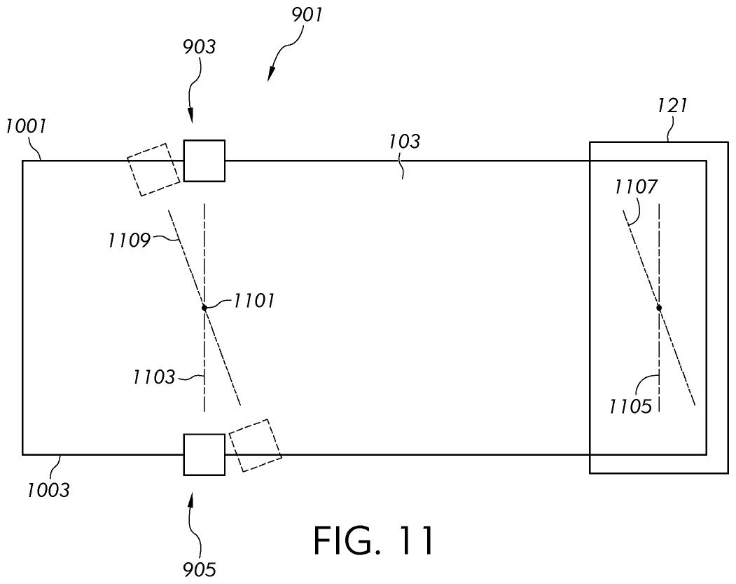

FIG. 11 illustrates a top-down view of the plurality of drag rollers 901, the glass ribbon 103, and the winding apparatus 121. In aspects, the plurality of drag rollers 901 can pivot about an axis 1101 to accommodate for a position of the glass ribbon 103. For example, to facilitate proper winding of the glass ribbon 103 onto the winding apparatus 121, a first roller axis 1103 (e.g., also illustrated in FIG. 10) of the plurality of drag rollers 901 can be parallel to a first winding axis 1105 of the winding apparatus 121. For example, the first drag roller 911 and the third drag roller 921 are each rotatable about a central axis. The first roller axis 1103 can extend between the first drag roller 911 and the third drag roller 921 and intersect a center of the first drag roller 911 and the third drag roller 921. In aspects, the winding apparatus 121 is rotatable about a first winding axis 1105 as the glass ribbon 103 is wound onto the winding apparatus 121. To provide for proper winding of the glass ribbon 103 onto the winding apparatus 121 and limit the likelihood of the glass ribbon 103 inadvertently contacting a flange of the winding apparatus 121, the first roller axis 1103 can be oriented substantially parallel to the first winding axis 1105.

In aspects, the glass ribbon 103 may become misaligned relative to the winding apparatus 121 and the plurality of drag rollers 901. By being misaligned, the glass ribbon 103 may be angled relative to the first roller axis 1103 and the first winding axis 1105, such as, for example, by being off-centered. To adjust for the position of the glass ribbon 103, in aspects, the winding apparatus 121 and the plurality of drag rollers 901 can be pivoted. For example, the winding apparatus 121 can pivot and extend along a second winding axis 1107, wherein the second winding axis 1107 is not parallel or coaxial with the first winding axis 1105. To facilitate a parallel alignment of the plurality of drag rollers 901 relative to the winding apparatus 121, the first set of drag rollers 903 and the second set of drag rollers 905 can likewise pivot about the axis 1101. For example, the first set of drag rollers 903 and the second set of drag rollers 905 can pivot and may extend along a second roller axis 1109. In aspects, the second roller axis 1109 may be substantially parallel to the second winding axis 1107. In this way, by being pivotable, the plurality of drag rollers 901 and the winding apparatus 121 can remain in a parallel orientation to accommodate for potential misalignment of the glass ribbon 103.

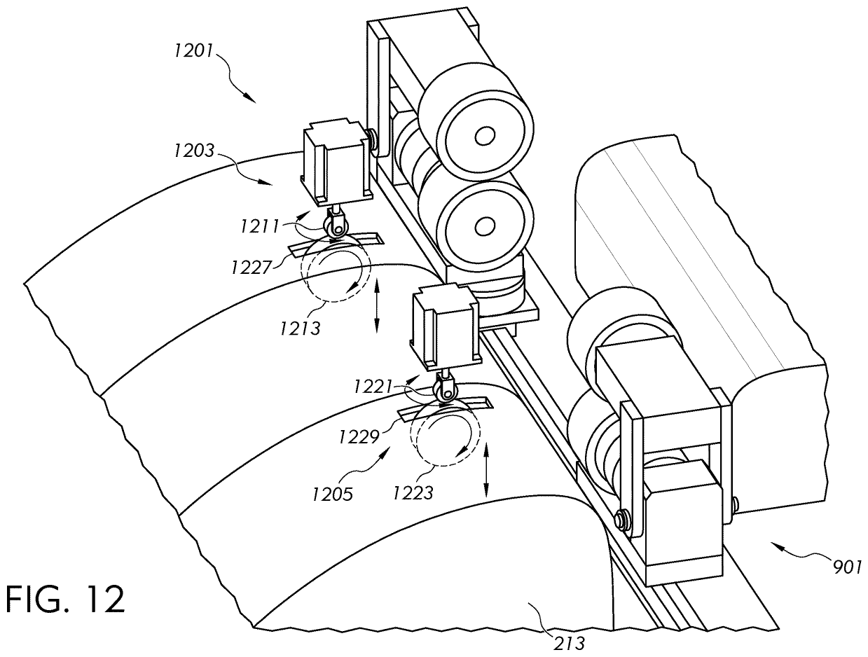

FIG. 12 illustrates a perspective view of the sixth support bearing 213. In aspects, the glass manufacturing apparatus 100 can comprise a plurality of drive rollers 1201 positioned upstream from the plurality of drag rollers 901. The plurality of drive rollers 1201 can contact the glass ribbon 103 and apply a force to cause the glass ribbon 103 to move in the travel direction toward the winding apparatus 121. In aspects, the plurality of drive rollers 1201 can comprise a first set of drive rollers 1203 positioned along the first edge 1001 of the glass ribbon 103, and a second set of drive rollers 1205 positioned along the second edge 1003 of the glass ribbon 103. The first set of drive rollers 1203 can comprise a first drive roller 1211 and a second drive roller 1213 spaced apart defining a gap within which the first edge 1001 of the glass ribbon 103 is received. The second set of drive rollers 1205 can comprise a third drive roller 1221 and a fourth drive roller 1223 spaced apart defining a second gap within which the second edge 1003 of the glass ribbon 103 is received.

The plurality of drive rollers 1201 can rotate while contacting the glass ribbon 103 as the glass ribbon 103 moves toward the winding apparatus 121. For example, the first drive roller 1211 and the third drive roller 1221 can be attached to a motor (e.g., servomotor, etc.) that can drive the first drive roller 1211 and the third drive roller 1221 to rotate independently of the presence of the glass ribbon 103. That is, the first drive roller 1211 and the third drive roller 1221 can be programmed to rotate at a predetermined speed, for example, a speed at which the glass ribbon 103 is moving. As such, when the glass ribbon 103 contacts the plurality of drive rollers 1201, the first drive roller 1211 and the third drive roller 1221 can be driven by the motor to apply a force to the glass ribbon 103, causing the glass ribbon 103 to move toward the winding apparatus 121. In aspects, the second drive roller 1213 and the fourth drive roller 1223 can extend through channels or openings in the sixth support bearing 213. For example, the second drive roller 1213 can extend through a first channel 1227 in a bearing surface of the sixth support bearing 213, and the fourth drive roller 1223 can extend through a second channel 1229 in the bearing surface of the sixth support bearing 213. In aspects, the second drive roller 1213 and the fourth drive roller 1223 may be movable between an engaged position, in which the second drive roller 1213 and the fourth drive roller 1223 are in contact with the glass ribbon 103, and a disengaged position, in which the second drive roller 1213 and the fourth drive roller 1223 are spaced apart and not in contact with the glass ribbon 103. To move to the disengaged position, the second drive roller 1213 and the fourth drive roller 1223 can move downwardly away from the glass ribbon 103. To move to the engaged position, the second drive roller 1213 and the fourth drive roller 1223 may move upwardly toward the glass ribbon 103.

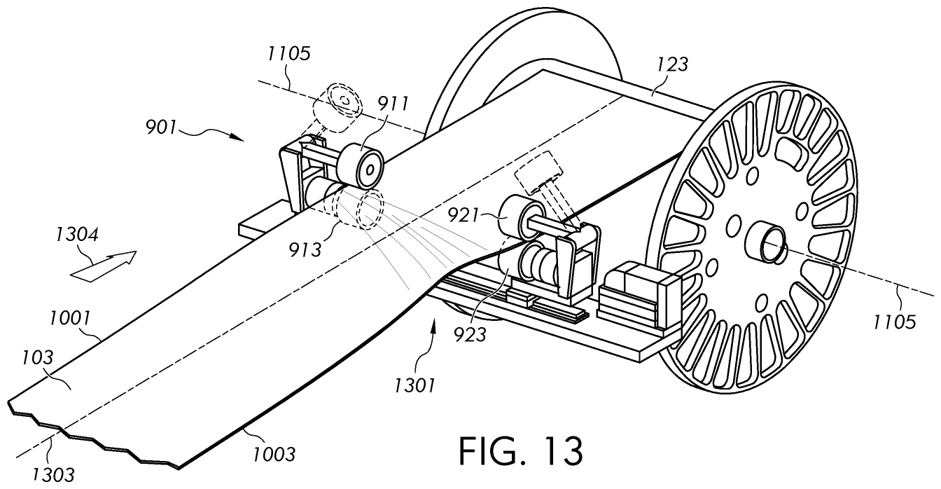

FIG. 13 illustrates a perspective view of the spool 123 as the glass ribbon 103 is wound onto the spool 123. FIG. 13 illustrates additional aspects of the glass manufacturing apparatus 100 in which the plurality of drag rollers 901 can simultaneously function as drive rollers, such that the plurality of drive rollers 1201 may not be provided. For example, the plurality of drag rollers 901 may be substantially similar to the plurality of drag rollers 901 illustrated in FIGS. 9-11. The plurality of drag rollers 901 can comprise the four drag rollers 911, 913, 921, 923 positioned upstream from the winding apparatus 121 and movable between a plurality of positions. In aspects, the second drag roller 913 and the fourth drag roller 923 can function substantially similarly to the first drive roller 1211 and the third drive roller 1221 of FIG. 11. For example, the second drag roller 913 and the fourth drag roller 923 can be attached to a motor (e.g., servomotor, etc.) that can drive the second drag roller 913 and the fourth drag roller 923 to rotate independently of the presence of the glass ribbon 103. In this way, the second drag roller 913 and the fourth drag roller 923 can be programmed to rotate at a predetermined speed, for example, a speed at which the glass ribbon 103 is moving. As such, when the glass ribbon 103 contacts the plurality of drag rollers 901, the second drag roller 913 and the fourth drag roller 923 can be driven by the motor to apply a force to the glass ribbon 103, causing the glass ribbon 103 to move toward the winding apparatus 121.

As illustrated in FIG. 13, the glass ribbon 103 may not be planar at a location upstream from the plurality of drag rollers 901. Rather, due to misalignment of the glass ribbon 103, the glass ribbon 103 may comprise a non-planar region 1301, such as, for example, a bump, a camber, or other convex or arched shape. In aspects, the non-planar region 1301 may be maintained upstream from the plurality of drag rollers 901 due to the plurality of drag rollers 901 contacting the edges 1001, 1003 of the glass ribbon 103. In aspects, the non-planar region 1301 can cause deformities in the glass ribbon 103 and/or may create problems with the winding process. To reduce the presence of the non-planar region 1301, the winding apparatus 121 and the plurality of drag rollers 901 can be pivoted. The pivoting can occur while maintaining the winding apparatus 121 and the plurality of drag rollers 901 in a substantially parallel orientation. For example, a centerline 1303 of the glass ribbon 103 can lie at a midpoint between the edges 1001, 1003, with the centerline 1303 extending along the glass ribbon 103 in a travel direction 1304 of the glass ribbon 103. In aspects, to ensure proper winding of the glass ribbon 103 and limiting the glass ribbon 103 from contacting edges of the spool 123, the centerline 1303 can be substantially perpendicular to the first winding axis 1105 of the spool 123.

The plurality of drag rollers 901 and the winding apparatus 121 can be pivoted without damaging the glass ribbon 103 or interfering with the winding process. For example, initially, the drag rollers 911, 913, 921, 923 may be in the closed position and in contact with the edges 1001, 1003 of the glass ribbon 103. The first drag roller 911 and the third drag roller 921 can pivot from the closed position (e.g., in contact with the glass ribbon 103) to the opened position, in which the first drag roller 911 and the third drag roller 921 are spaced apart from, and not in contact with, the edges 1001, 1003 of the glass ribbon 103. With the first drag roller 911 and the third drag roller 921 not in contact with the glass ribbon 103, the plurality of drag rollers 901 and the spool 123 can be pivoted, for example, in a similar manner as the pivoting about axes 1103, 1105, 1107, 1109 illustrated in FIG. 11. The glass ribbon 103 may therefore not be disrupted or damaged during the pivoting by the plurality of drag rollers 901. Accordingly, as illustrated in FIGS. 10-14, methods can comprise changing a travel path of the glass ribbon 103 by moving the first set of drag rollers 903 and the second set of drag rollers 905.

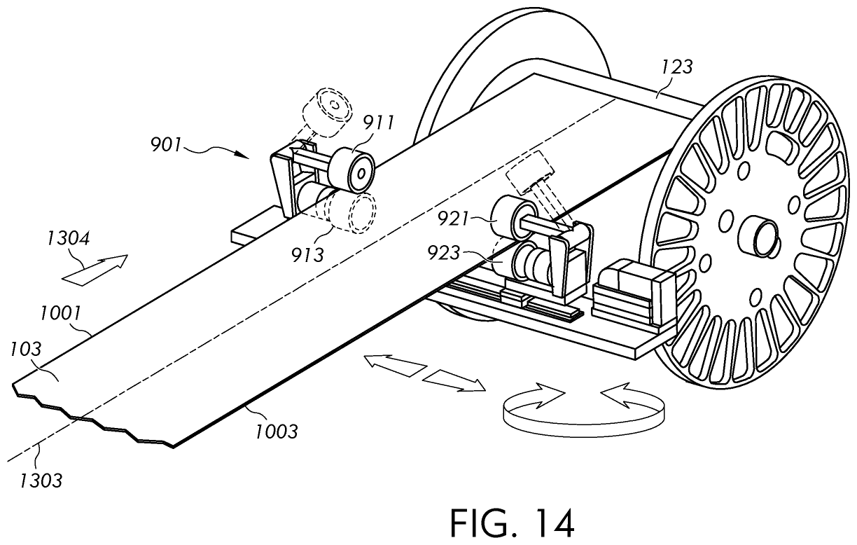

FIG. 14 illustrates the winding apparatus 121 and the plurality of drag rollers 901 after pivoting to remove the non-planar region 1301. For example, the winding apparatus 121 and the plurality of drag rollers 901 can be pivoted in a direction that removes the non-planar region 1301 and planarizes the glass ribbon 103. In addition, or in the alternative, the first set of drag rollers 903 and the second set of drag rollers 905 can be moved to adjust a separating distance between the first set of drag rollers 903 and the second set of drag rollers 905, similar to the adjustment of the distances 1011, 1013 illustrated in FIG. 10. During the movement of the plurality of drag rollers 901, the glass ribbon 103 may be unconstrained by the first set of drag rollers 903 and the second set of drag rollers 905, due to the first drag roller 911 and the third drag roller 921 being in the opened position. Once the non-planar region 1301 has been removed and the glass ribbon 103 is planar, the first drag roller 911 and the third drag roller 921 can be moved from the opened position to the closed position. For example, the first drag roller 911 and the third drag roller 921 can move downwardly to the closed position such that the edges 1001, 1003 of the glass ribbon 103 can be constrained by the first set of drag rollers 903 and the second set of drag rollers 905. In aspects, as the glass ribbon 103 is wound onto the spool 123, the second drag roller 913 and the fourth drag roller 923 may no longer apply the driving force to the glass ribbon 103. Rather, the second drag roller 913 and the fourth drag roller 923 can rotate freely, with the rotation of the second drag roller 913 and the fourth drag roller 923 caused by the movement of the glass ribbon 103. Instead of the driving force originating from the second drag roller 913 and the fourth drag roller 923, the spool 123 can be attached to a motor that can drive the spool 123 to rotate independently of the presence of the glass ribbon 103. That is, the motor can be programmed to rotate the spool 123 at a predetermined speed, for example, a speed at which the glass ribbon 103 is moving. As such, the spool 123 can be driven by the motor to rotate, thus causing the glass ribbon 103 to move toward and about the spool 123.

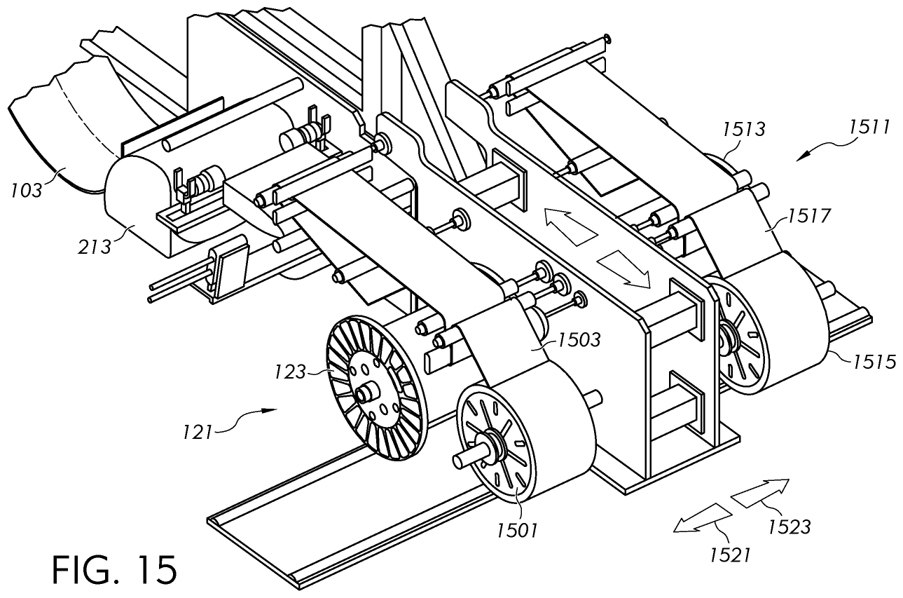

FIG. 15 illustrates a perspective view of the winding apparatus 121 comprising the spool 123, positioned downstream from the sixth support bearing 213. In aspects, the winding apparatus 121 can comprise an interleaf spool 1501 comprising an interleaf material 1503. The interleaf material 1503 can be wrapped around the interleaf spool 1501. In aspects, the interleaf material 1503 can comprise a width that is greater than or equal to a width of the glass ribbon 103. The interleaf material 1503 can comprise, for example, a polyethylene foam, a corrugated paper material, a sheet of polyvinyl material, etc. The interleaf material 1503 can be wound around the spool 123 with the glass ribbon 103, with the interleaf material 1503 positioned between layers of the glass ribbon 103. In this way, the interleaf material 1503 can protect the glass ribbon 103, for example, due to vibration during transport. As the glass ribbon 103 is wound onto the spool, the interleaf material 1503 can be positioned adjacent to a major surface of the glass ribbon 103 such that the interleaf material 1503 and the glass ribbon 103 can be wound together onto the spool 123.

In aspects, a second winding apparatus 1511 can be positioned adjacent to the winding apparatus 121, with the second winding apparatus 1511 substantially identical to the winding apparatus 121. For example, the second winding apparatus 1511 can comprise a second spool 1513 (e.g., substantially identical to the spool 123), a second interleaf spool 1515 (e.g., substantially identical to the interleaf spool 1501) and a second interleaf material 1517 (e.g., substantially identical to the interleaf material 1503). In aspects, as the glass ribbon 103 and the interleaf material 1503 are wound onto the spool 123, the second winding apparatus 1511 may remain positioned adjacent to the winding apparatus 121, with the second interleaf material 1517 wound onto the second interleaf spool 1515.

After a period of time, an entire length of the glass ribbon 103 may be wound onto the spool 123 along with the interleaf material 1503. To limit downtime, the winding apparatus 121 and the second winding apparatus 1511 can be moved in a first direction 1521, such that the second winding apparatus 1511 can take the position of the winding apparatus 121. At this point, a new glass ribbon can pass by the support bearings, and may be wound onto the second spool 1513, with the second interleaf material 1517 concurrently being wound with the new glass ribbon onto the second spool 1513. During the winding, the spool 123 can be removed and prepared for transportation (e.g., by being placed in a container), with the spool 123 being replaced with an empty spool. Accordingly, downtime can be limited such that, when the second spool 1513 has a full glass ribbon, the second winding apparatus 1511 can be moved in a second direction 1523, opposite the first direction 1521, to prepare the second spool 1513 for transportation.

The glass manufacturing apparatus 100 can provide several benefits. For example, the contact between the glass ribbon 103 and a surface may be minimized, for example, due to the presence of the support bearings, which can support the glass ribbon 103 by emitting gas from one or more openings. Further, the glass ribbon 103 can be limited from becoming off-centered relative to the support bearings, due to the presence of the zones within the support bearings, wherein the zones can guide the glass ribbon 103 in a direction transverse to the travel direction of the glass ribbon 103. In addition, the drag rollers and the winding apparatus can move (e.g., pivot, adjust, etc.) to accommodate for non-planar regions of the glass ribbon 103, thus improving the spooling of the glass ribbon 103.

It should be understood that while various aspects have been described in detail relative to certain illustrative and specific examples thereof, the present disclosure should not be considered limited to such, as numerous modifications and combinations of the disclosed features are possible without departing from the scope of the following claims.

1. A glass manufacturing apparatus comprising:
a forming apparatus configured to form a glass ribbon and defining a first travel path of the glass ribbon;
a support bearing comprising a bearing surface and a plurality of openings through which gas exits to impinge upon the glass ribbon, the support bearing configured to move between a first position, in which the bearing surface is spaced a distance apart from the first travel path, and a second position, in which the bearing surface engages the glass ribbon and guides the glass ribbon to move along a second travel path different from the first travel path.

2. The glass manufacturing apparatus of claim 1, wherein the support bearing comprises:
a first zone comprising a first portion of the plurality of openings through which gas exits and configured to impart a first force upon the glass ribbon;
a second zone comprising a second portion of the plurality of openings through which gas exits and configured to impart a second force less than the first force upon the glass ribbon.

3. The glass manufacturing apparatus of claim 1, further comprising a first set of drag rollers and a second set of drag rollers spaced apart and positioned downstream from the support bearing, the first set of drag rollers configured to engage a first edge of the glass ribbon and the second set of drag rollers configured to engage an opposing second edge of the glass ribbon.

4. The glass manufacturing apparatus of claim 3, wherein the first set of drag rollers comprises a first drag roller and a second drag roller spaced apart defining a gap, the first edge of the glass ribbon received within the gap, and wherein the second set of drag rollers comprises a third drag roller and a fourth drag roller spaced apart defining a second gap, the second edge of the glass ribbon received within the second gap.

5. The glass manufacturing apparatus of claim 4, wherein the first set of drag rollers and the second set of drag rollers are movable between a first position, in which a first distance separates the first set of drag rollers and the second set of drag rollers, and a second position, in which a second distance separates the first set of drag rollers and the second set of drag rollers, the first distance different than the second distance.

6. The glass manufacturing apparatus of claim 4, wherein the first drag roller is movable relative to the second drag roller to adjust a size of the gap.

7. The glass manufacturing apparatus of claim 3, further comprising a drive roller extending through an opening in the bearing surface and positioned upstream from the first set of drag rollers and the second set of drag rollers, the drive roller configured to engage the glass ribbon.

8. A glass manufacturing apparatus comprising:
a forming apparatus configured to form a glass ribbon and defining a first travel path of the glass ribbon;
a support bearing comprising a bearing surface and a plurality of openings through which gas exits to impinge upon the glass ribbon, the support bearing comprising:
a first zone comprising a first portion of the plurality of openings through which gas exits and configured to impart a first force upon the glass ribbon;
a second zone comprising a second portion of the plurality of openings through which gas exits and configured to impart a second force less than the first force upon the glass ribbon; and
a gas source in fluid communication with the support bearing, the gas source configured to deliver gas to the support bearing and through the plurality of openings to guide the glass ribbon.

9. The glass manufacturing apparatus of claim 8, further comprising a first set of drag rollers and a second set of drag rollers spaced apart and positioned downstream from the support bearing, the first set of drag rollers configured to engage a first edge of the glass ribbon and the second set of drag rollers configured to engage an opposing second edge of the glass ribbon.

10. The glass manufacturing apparatus of claim 9, wherein the first set of drag rollers comprises a first drag roller and a second drag roller spaced apart defining a gap, the first edge of the glass ribbon received within the gap, and wherein the second set of drag rollers comprises a third drag roller and a fourth drag roller spaced apart defining a second gap, the second edge of the glass ribbon received within the second gap.

11. The glass manufacturing apparatus of claim 10, wherein the first set of drag rollers and the second set of drag rollers are movable between a first position, in which a first distance separates the first set of drag rollers and the second set of drag rollers, and a second position, in which a second distance separates the first set of drag rollers and the second set of drag rollers, the first distance different than the second distance.

12. The glass manufacturing apparatus of claim 10, wherein the first drag roller is movable relative to the second drag roller to adjust a size of the gap.

13. The glass manufacturing apparatus of claim 9, further comprising a drive roller extending through a channel in the bearing surface and positioned upstream from the first set of drag rollers and the second set of drag rollers, the drive roller configured to engage the glass ribbon.

14. A method of manufacturing a glass ribbon comprising:
moving the glass ribbon along a first travel path in a first travel direction;
emitting gas from a support bearing; and
moving the support bearing from a first position, in which the support bearing is spaced a distance apart from the first travel path, to a second position, in which gas from the support bearing impinges upon the glass ribbon and guides the glass ribbon to move along a second travel path different from the first travel path.

15. The method of claim 14, wherein the emitting gas comprising emitting gas from a first zone of the support bearing comprising a first portion of a plurality of openings and imparting a first force upon the glass ribbon, and emitting gas from a second zone of the support bearing comprising a second portion of the plurality of openings and imparting a second force upon the glass ribbon, the second force less than the first force.

16. The method of claim 15, wherein the first zone and the second zone are arranged substantially perpendicular to the second travel path.

17. The method of claim 14, further comprising contacting the glass ribbon with a first set of drag rollers and a second set of drag rollers positioned downstream from the support bearing relative to the first travel direction.

18. The method of claim 17, further comprising changing a travel path of the glass ribbon by moving the first set of drag rollers and the second set of drag rollers.

19. The method of claim 17, further comprising, at a location upstream from the contacting the glass ribbon with the first set of drag rollers and the second set of drag rollers, providing a portion of the glass ribbon as unsupported and hanging freely under the influence of gravity.
